(19) United States
(12) Patent Application Publication
(10) Pub. No.: US 2012/0289337 A1
(43) Pub. Date: Nov. 15, 2012

(54) VIDEO GAME CONTROLLER DISPLAY

(75) Inventor: Aaron B. Sternberg, Scottsdale, AZ (US)

(73) Assignee: IPPASA, LLC, Vancouver, WA (US)

(21) Appl. No.: 13/471,284

(22) Filed: May 14, 2012

Related U.S. Application Data
(60) Provisional application No. 61/486,175, filed on May 13, 2011.

(51) Int. Cl. A63F 13/06

(52) U.S. Cl. 463/37

(57) ABSTRACT

A video game controller for manipulating images or symbols on an image display comprises an activity counter that produces a cumulative record corresponding to a measure of game player usage of the video game controller over multiple sessions of game play. An information display located on the video game controller housing and operatively associated with the activity counter provides a readout of the cumulative record produced.

### RELATED APPLICATION

This application claims benefit of U.S. Provisional Patent Application No. 61/486,175, filed May 13, 2011.

### COPYRIGHT NOTICE

© 2012 IPPASA, LLC. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This disclosure relates to video game controllers and, in particular, to a video game controller that keeps track of game player usage by visual display of a cumulative record corresponding to a measure of game player usage of the video game controller over multiple sessions of game play.

### BACKGROUND INFORMATION

The video game controller has been an integral part of the video game experience for decades. Such controllers are one of the most used input devices other than a computer keyboard or mouse. The usage habits of video game players range in type from hardcore game players or “garners” who participate in game play nonstop for several hours to casual game players who play for twenty to thirty minutes at a time. Regardless of the type of video game player, an undeniable fact is that video game controllers undergo a lot of wear and tear. Video game players can purchase either new or used video game controllers. Retailers such as GameStop™ carry a huge selection of used video games, consoles, and accessories for sale. When purchasing used video game controllers, retailers and consumers perform various testing methods to facilitate the decision whether to buy.

Certain retailers have a special computer that tests controller functionality, and consumers are often able to connect the controller to a video game system in the store or activate the various buttons to make sure they do not stick.

Another key part of video game play has always been some form of acknowledgment of accomplishment—whether it be the “high score,” or achievements recognition given by system providers, such as the Xbox™ Live Service from Microsoft Corporation, Trophies from the PSN Network from Sony Corporation, or Leaderboards in mobile game applications (apps). Video game players of any type enjoy being recognized and acknowledged for their gaming prowess and accomplishments.

### SUMMARY OF THE DISCLOSURE

A video game controller for manipulating images or symbols on an image display comprises an activity counter that produces a cumulative record corresponding to a measure of game player usage of the video game controller over multiple sessions of game play. An information display located on the video game controller housing and operatively associated with the activity counter provides a readout of the cumulative record produced. Examples of measures of game player usage include a total time of game play elapsed over multiple sessions of game play and a predetermined game player action occurring during game play.

In a first embodiment, a timer residing in the video game housing responds to game player manipulation of a control actuator set to produce signal information indicative of game player usage. The timer processes the time of game play elapsed over each of the multiple sessions of game play so that the activity counter can produce for readout the total time of game play elapsed over the multiple sessions.

In a second embodiment, a video game is implemented in software operating on a central processing unit (CPU)-enabled device such as, for example, a video game console that produces signal information indicative of the game player usage. A communication link between the activity counter and the CPU-enabled device provides the signal information so that the activity counter can produce for readout the cumulative record corresponding to the game player usage.

Additional aspects and advantages will be apparent from the following detailed description of preferred embodiments, which proceeds with reference to the accompanying drawings.

### BRIEF DESCRIPTION OF THE DRAWINGS

FIG. 1 is a simplified block diagram of a video game system that includes the disclosed video game controller.

FIG. 2 is a pictorial diagram of the disclosed video game controller having a multi-digit, seven-segment display device that is positioned on the upper surface of the housing of the video game controller.

### DETAILED DESCRIPTION OF PREFERRED EMBODIMENTS

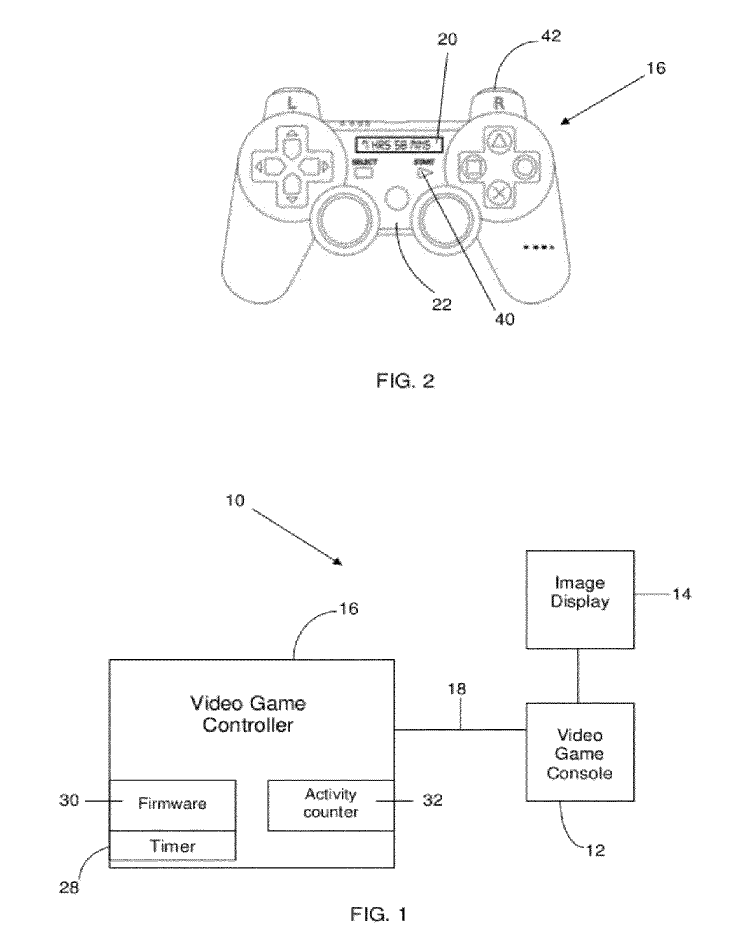

FIG. 1 shows a video game system 10 that includes a video game console 12 on which a video game implemented in software operates. Video game console 12 is one of several preferred CPU-enabled devices on which video game software may operate. Other preferred CPU-enabled devices include, for example, a personal computer, smartphone, multimedia device, and tablet computer. Video game console 12 produces signal information in the form of images or symbols representing game play activity for display on an image display device 14. A manual video game controller 16 delivers by a wired or wireless communication link 18 to video game console 12 commands produced by the game player's manipulation of actuators provided on or in video game controller 16. The game player's commands cause changes to the states of image or symbols displayed in response to video game software instructions executed in accordance with the game player's commands. FIG. 2 shows a multi-digit, seven-segment information display device 20 positioned on the top surface of a housing 22 of video game controller 16. Information display device 20 resembles an odometer-type readout that displays information indicating the cumulative time of game play performed on video game controller 16.

In a first embodiment, an integrated information display device 20 positioned on and firmware 30 contained in video game controller 16 cooperate to keep track of the amount of time video game controller 16 has been used in game play. For example, with reference to FIG. 2, a video game player picks up video game controller 16 equipped with information display device 20 and plays a video game for the first time for two sessions, the first session lasting three hours, and the second session lasting four hours. When he picks up video game controller 16 for the third session and observes the readout on information display device 20, the video game player will see that video game controller 16 has been used for seven hours. This total time-played readout display for a particular video game controller 16 helps the retailer and the consumer better ascertain whether the controller is a good candidate for purchase. Moreover, information display device 20 provides a video game player with an opportunity for self-congratulatory acknowledgment of personal accomplishment and bragging rights by showing to friends video game controller 16 with a display readout of the amount of time the player has devoted to playing video games on video game controller 16.

A timer 28 forming part of firmware 30 resides in housing 22 of video game controller 16 and locally determines the time of game play elapsed over each of the multiple sessions. Timer 28 provides the determined elapsed time to an activity counter 32 in video controller 16. Activity counter 32 produces for display on information display device 20 the total time of game play elapsed over the multiple sessions. Timer 28 functions in response to a control actuator set provided on or in video game controller 16. A control actuator set may include one or more control buttons, one or more control sensors, or a combination of one or more control buttons and control sensors that respond to game player manipulation.

In one implementation, a game player depresses a button set including a start button 40 (FIG. 2) to begin game play and produce a first signal the causes timer 28 to start marking time. Upon completion of the game play session, the game player depresses start button 40 to conclude game play and produce a second signal that causes timer 28 to conclude marking time.

In another implementation, a game player depresses start button 40 to begin game play and manipulates repeatedly any number of the control actuators as he plays the game. A selected actuator 42 (“R” button arbitrarily chosen in FIG. 2) produces a signal in response to each manipulation by the game player and causes timer 28 to start marking time in response to occurrence of the last one of a predetermined number of (e.g., three) instances of the game player manipulation. Timer 28 concludes marking time upon expiration of a preset time after which actuator 42 has not been manipulated.

Skilled persons will appreciate that other implementations are possible for starting and stopping timer 28 appropriately to determine time elapsed over a game play session.

For any implementation of starting and stopping timer 28, activity counter 32 continuously tracks the elapsed time during the game play session and may update information display device 20 in real time during game play or upon completion of a game play session.

In a second embodiment, information display device 20 may also be used to assist a game player in keeping track of certain game play activity by display of a cumulative record of predetermined actions. As a first example, for a game player playing First Person Shooters, otherwise known as FPS, video game controller 16 keeps track of the total number of kills achieved during multiple FPS games played by the game player. Creating a record of cumulative number of kills is enabled by software that communicates, from video console 12 through communication link 18, information that increments activity counter 32 in video game controller 16. As a second example, if a game player played Call of Duty™ and killed 10 enemies, and thereafter played Halo™ and killed 45 enemies, the next time the game player picks up controller 16 it would display the number 55, representing the current cumulative number of kills achieved. This aspect of the embodiment relies not on time of usage of the controller itself but on receipt by firmware 30 of game play-related activity signals produced by game software stored in video game console 12.

Although the preferred embodiments are described with reference to use of a video game controller of the PS3™ type shown in FIG. 2, the disclosed information display can be implemented in other controllers such as keyboards, mice, and video game steering wheels.

It will be obvious to skilled persons that many changes may be made to the above-described embodiments without departing from the underlying principles thereof. For example, video game controller 16 can be configured to selectively determine and display elapsed time of game play and keep track of and display a record of instances of certain game play activity. The scope of the present invention should, therefore, be determined only by the following claims.

1. A video game controller for manipulating images or symbols on a display, comprising:
an activity counter producing a cumulative record corresponding to a measure of game player usage of the video game controller over multiple sessions of game play; and
an information display located on the video game controller and operatively associated with the activity counter to provide a readout of the cumulative record corresponding to the measure of game player usage.

2. The video game controller of claim 1, in which the cumulative record corresponding to the measure of game player usage is a total time of game play elapsed over the multiple sessions of game play.

3. The video game controller of claim 1, in which the measure of game play usage is a predetermined game player action occurring during game play.

4. The video game controller of claim 3, in which the cumulative record is a total number of instances of the predetermined game player action that occurred over the multiple sessions of game play.

5. The video game controller of claim 1, in which a video game is implemented in software operating on a CPU-enabled device that produces signal information indicative of the game player usage, and further comprising a communication link between the activity counter and the CPU-enabled device to provide the signal information so that the activity counter can produce for readout the cumulative record corresponding to the game player usage.

6. The video game controller of claim 5, in which, the CPU-enabled device is a video game console.

7. The video game controller of claim 5, in which the CPU-enabled device is a personal computer.

8. The video game controller of claim 5, in which the CPU-enabled device is a smartphone.

9. The video game controller of claim 5, in which the CPU-enabled device is a multimedia device.

10. The video game controller of claim 5, in which the CPU-enabled device is a tablet computer.

11. The video game controller of claim 1, in which the cumulative record corresponding to the measure of game player usage is a total time of game play over the multiple sessions of game play, and further comprising a locally residing timer operatively associated with the activity counter and a control actuator set operable in response to game player manipulation to produce for delivery, to the locally residing timer, signal information indicative of the game player usage, the locally residing timer processing the signal information to determine a time of game play elapsed over each of the multiple sessions of game play so that the activity counter can produce for readout the total time of game play elapsed over the multiple sessions of game play.

12. The video game controller of claim 11, in which the control actuator includes a button set that a game player operates to produce the signal information indicative of the game player usage.

13. The video game controller of claim 11, in which the locally residing timer responds to multiple successive instances of the game player manipulation to produce the signal information indicative of the game player usage.
